(19) United States
(12) Patent Application Publication
(10) Pub. No.: US 2007/0212203 A1
(43) Pub. Date: Sep. 13, 2007

(54) Pallet tow carriage

(76) Inventor: Mohammed Sadeek, Miramar, FL (US)

Correspondence Address: FRANK L. KUBLER, 13261 S.W. 54th Court, Miramar, FL, 33027, US

(21) Appl. No.: 11/199,554

(22) Filed: Aug. 8, 2005

(51) Int. Cl. B65G 1/00

(52) U.S. Cl. 414/286

(57) ABSTRACT

A pallet tow carriage for engaging a pallet having a pallet first end and a pallet second end and a pallet top panel and a pallet bottom panel and a pallet interior for towing, including a carriage body for positioning at a first end of a pallet, first and second wheel mounting structures secured to the carriage body in spaced relation from each other, a tilt lever structure fastened to the carriage body and extending upwardly from the carriage body and a lifting arm structure extending rearwardly from the carriage body for fitting into a pallet interior; a carriage wheel rotatably mounted to each wheel mounting structure and extending below the carriage body; a pallet engagement structure connected to the carriage body for connecting a pallet to the carriage body; and a tow vehicle connecting mechanism for connecting the tilt lever structure to a tow vehicle.

### BACKGROUND OF THE INVENTION

1. Field of the Invention

The present invention relates generally to the field of merchandise transportation vehicles such as fork lifts and pallet jacks. More specifically the present invention relates to a pallet tow carriage including a carriage body for positioning at a first end of a pallet, first and second wheel mounting structures secured to the carriage body in spaced relation, a carriage wheel rotatably mounted to each wheel mounting structure and extending below the carriage body, a tilt lever structure fastened to the carriage body and extending upwardly from the carriage body, a pair of pallet lifting arms extending rearwardly from the carriage body, a pallet engagement structure connected to the carriage body for connecting a pallet to the carriage body, and tow vehicle connecting means for connecting the tilt lever structure to a tow vehicle, so that the pallet engagement structure can engage a pallet while the carriage body is adjacent a pallet first end, and the tow vehicle connecting means can connect the tilt lever structure to a tow vehicle such as a fork lift and the towing vehicle can advance away from the pallet and thereby pull the tilt lever structure away from the pallet, tilting the carriage body upward to ride on the carriage wheels and thereby lifting the pallet first end while the opposing pallet second end rests on a support surface and is dragged over the support surface as the carriage and pallet are towed.

The pallet engagement structure preferably includes two pallet hook members in the form of elongate rods each having a member hooking end and a member locking end. Each hook member fits through the open interior of a pallet so the member hooking ends hook opposing upright pallet ribs at the pallet second end and the hook member locking ends protrude out of the pallet first end. The carriage body preferably is a channel member formed of metal and of rectangular cross-section having two longitudinally spaced apart series of hook member passing slots at each carriage bar end. The hook member locking ends are fitted forwardly through respective hook member passing slots selected within the respective slot sets for matching the spacing of the pallet ribs of the particular pallet. A hook holding pin is fitted through a port in each hook member locking end forward of the carriage body to abut the carriage body when the carriage body is towed.

The tilt lever structure preferably includes two laterally spaced apart upright tilt brackets secured at tilt bracket lower ends to the carriage bar and having tilt bracket connection ports at tilt bracket upper ends and including upper and lower linking struts extending between and structurally interconnecting the tilt brackets. The tow vehicle connecting means preferably include a linking chain connected to the tilt bracket connection ports and extending between the tilt brackets, and a pull chain connected to the linking chain and to the tow vehicle.

2. Description of the Prior Art

There have long been pallet jacks for lifting pallets loaded with up to 5500 pounds of merchandise boxes. A problem with these pallet jacks has been the lifting limit, because they are inadequate for moving multiple pallet and box stacks within truck containers to load and unload the containers. Each pallet and box stack in a container can weight as much as 8000 pounds.

It is thus an object of the present invention to provide a pallet tow carriage having a lifting capacity for moving full pallet and box stacks within truck containers.

It is another object of the present invention to provide such a pallet tow carriage which can move these stacks safely, with minimal risk of stack collapse.

It is still another object of the present invention to provide such a pallet tow carriage which can pull a pallet and box stack along a curved path to permit maneuvering of stacks within a container.

It is finally an object of the present invention to provide such a pallet tow carriage which is sturdy, easy to use and inexpensive to manufacture.

### SUMMARY OF THE INVENTION

The present invention accomplishes the above-stated objectives, as well as others, as may be determined by a fair reading and interpretation of the entire specification.

A pallet tow carriage for engaging a pallet having a pallet first end and a pallet second end and a pallet top panel and a pallet bottom panel and a pallet interior for towing, including a carriage body for positioning at a first end of a pallet, first and second wheel mounting structures secured to the carriage body in spaced relation from each other, a tilt lever structure fastened to the carriage body and extending upwardly from the carriage body and a lifting arm structure extending rearwardly from the carriage body for fitting into a pallet interior; a carriage wheel rotatably mounted to each wheel mounting structure and extending below the carriage body; a pallet engagement structure connected to the carriage body for connecting a pallet to the carriage body; and a tow vehicle connecting mechanism for connecting the tilt lever structure to a tow vehicle; so that the pallet engagement structure can engage a pallet while the carriage body is adjacent a pallet first end, and the tow vehicle connecting mechanism can connect the tilt lever structure to a tow vehicle and the towing vehicle can advance away from the pallet and thereby pull the tilt lever structure away from the pallet, tilting the carriage body upward to ride on the carriage wheels and thereby lifting the pallet first end while the opposing pallet second end rests on a support surface and is dragged over the support surface as the carriage and the pallet are towed.

The pallet preferably has two spaced apart pallet ribs, a top panel, an bottom panel and an open interior, where the pallet engagement structure includes two pallet hook members in the form of elongate rods each having a member hooking end and a member locking end, so that each hook member can be fitted through a pallet and the member hooking ends hook opposing upright pallet ribs at a pallet second end and the hook member locking ends protrude out of the pallet first end. The carriage body preferably includes a carriage bar having two carriage body ends and two longitudinally spaced apart series of hook member passing slots at each carriage body end, so that the hook member locking ends can be fitted forwardly through respective hook member passing slots selected within the respective slot sets for matching the spacing of pallet ribs of a particular pallet to be engaged.

The wheel mounting structure preferably includes a pair of wheel mounting brackets protruding forwardly from the carriage body, having registering wheel bracket ports through which a wheel axle is fitted and on which a cylindrical carriage wheel is mounted between the wheel mounting brackets forming each bracket pair, wherein each wheel protrudes downwardly below the carriage bar. The pallet tow carriage preferably additionally includes a hook holding pin fitted through a port in each hook member locking end forward of the carriage body to abut the carriage body when the carriage body is towed.

The tilt lever structure preferably includes two laterally spaced apart upright tilt brackets secured at tilt bracket lower ends to the carriage body and having tilt bracket connection ports at tilt bracket upper ends and comprising a linking strut extending between and structurally interconnecting the tilt brackets. The tow vehicle connecting mechanism preferably includes a linking chain connected to the tilt bracket connection ports and extending between the tilt brackets; and a pull chain connected to the linking chain and to the tow vehicle.

A pallet tow carriage for engaging a pallet having a pallet first end and a pallet second end and a pallet top panel and a pallet bottom panel and a pallet interior for towing, including a carriage body for positioning at a first end of a pallet, a wheel mounting structure secured to the carriage body and a tilt lever structure fastened to the carriage body and extending upwardly from the carriage body and a lifting arm structure extending rearwardly from the carriage body for fitting into a pallet interior; a carriage wheel rotatably mounted to the wheel mounting structure and extending below the carriage body; a pallet engagement structure connected to the carriage body for connecting a pallet to the carriage body; and tow vehicle connecting mechanism for connecting the tilt lever structure to a tow vehicle; so that the pallet engagement structure can engage a pallet while the carriage body is adjacent a pallet first end, and the tow vehicle connecting mechanism can connect the tilt lever structure to a tow vehicle and the towing vehicle can advance away from the pallet and thereby pull the tilt lever structure away from the pallet, tilting the carriage body upward to ride on the carriage wheel and thereby lifting the pallet first end while the opposing pallet second end rests on a support surface and is dragged over the support surface as the carriage and the pallet are towed.

Where the pallet has two spaced apart pallet ribs, a top panel, an bottom panel and an open interior, the pallet engagement structure preferably includes two pallet hook members in the form of elongate rods each having a member hooking end and a member locking end, so that each hook member can be fitted through a pallet and the member hooking ends hook opposing upright pallet ribs at a pallet second end and the hook member locking ends protrude out of the pallet first end; and preferably including a hook holding pin fitted through a port in each hook member locking end forward of the carriage body to abut the carriage body when the carriage body is towed.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a front perspective view of the preferred embodiment of the present pallet tow carriage.

FIG. 2 is a broken away perspective view of a segment of the carriage body and one of the wheel mounting structures and mounted wheel, showing a wheel mounted on a wheel axle.

FIG. 3 is a rear perspective view of the embodiment of FIG. 1 with the hooking arms broken away, showing the lifting arms.

FIG. 4 is cross-sectional view of the carriage body and a pallet lifting arm fitted into an arm receiving tube welded within the channel member forming the carriage body, and of a plate welded across the open face of the channel member with a lifting arm receiving tube passing port for providing structural support to the arm receiving tube and pallet lifting arm.

FIG. 5 is a top view of a pallet engaged by the tow carriage and with the pallet top panel removed showing how the pallet hook members releasibly engage pallet ribs for towing.

FIG. 6 is a side view of the pallet and tow carriage with the nearest pallet rib removed.

FIG. 7 is a perspective view of the two carriage engaging a pallet supporting the transport items.

FIG. 8 is a perspective view of a stack of pallets and transport items engaged by the present tow carriage and being towed by a tow vehicle.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

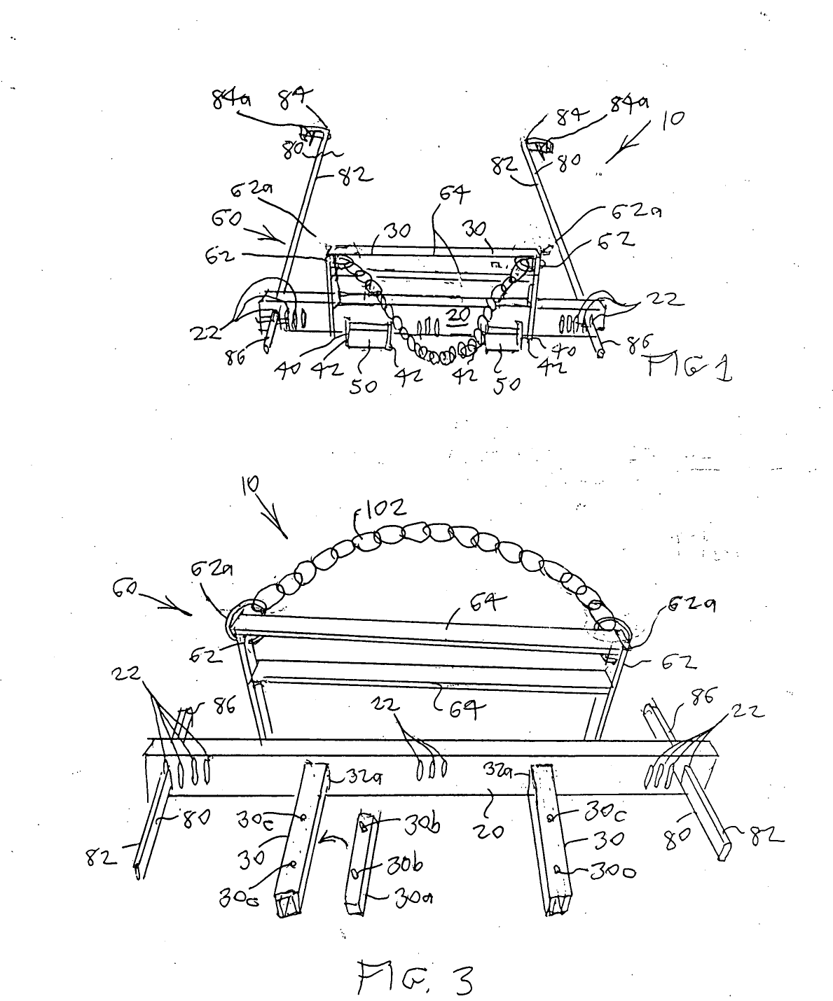

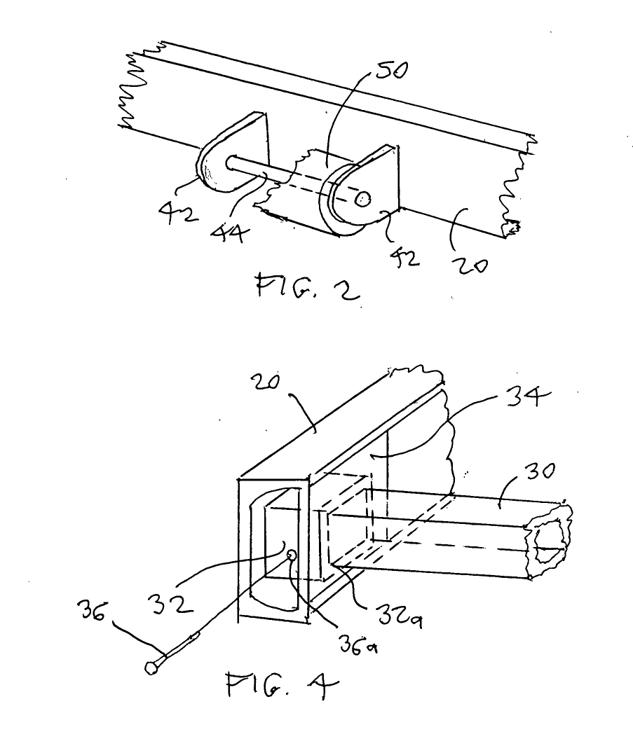

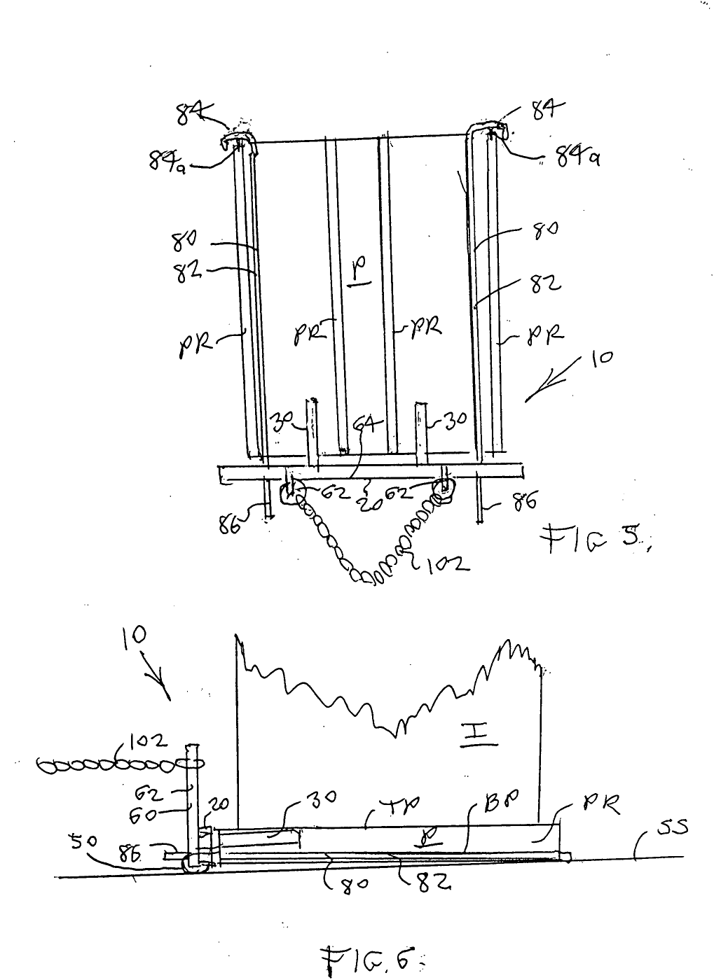

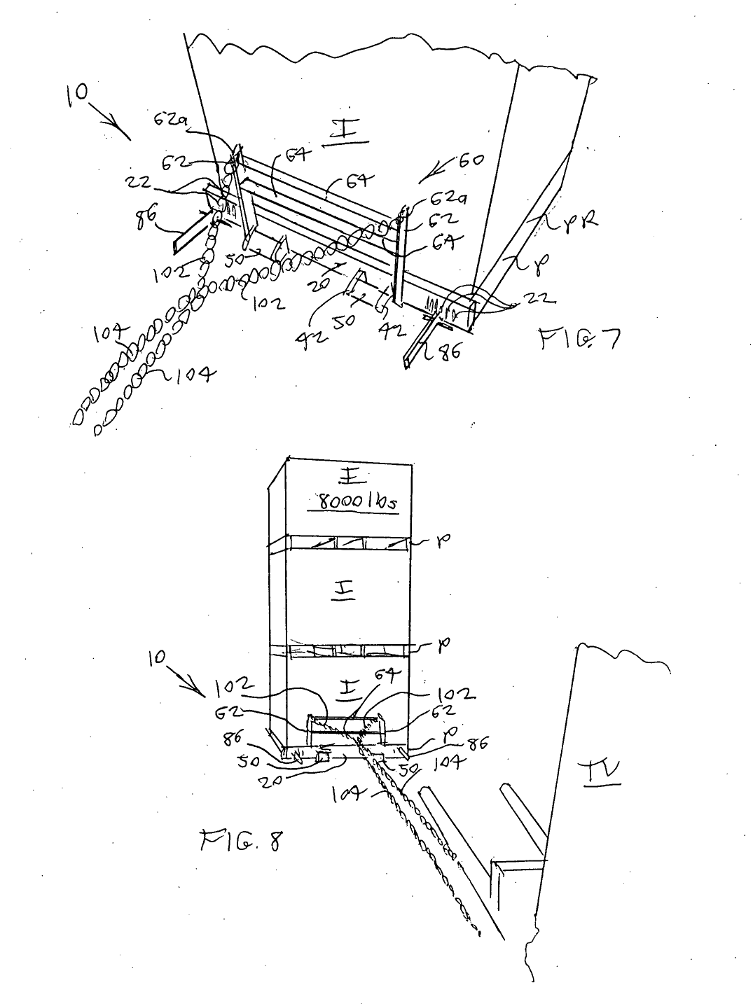

Referring to FIGS. 1-8, a pallet tow carriage 10 is disclosed including a carriage body 20 for positioning at a first end of a pallet P, first and second wheel mounting structures 40 secured to the carriage body 20 in spaced relation from each other, a carriage wheel 50 rotatably mounted to each wheel mounting structure 40 and extending below the carriage body 20, a tilt lever structure 60 fastened to the carriage body 20 and extending upwardly from the carriage body 20, a pair of pallet lifting arms 30 extending rearwardly from the carriage body 20, a pallet engagement structure 80 connected to the carriage body 20 for connecting a pallet P to the carriage body 20, and tow vehicle connecting means 100 for connecting the tilt lever structure 60 to a tow vehicle TV, so that the pallet engagement structure 80 can engage a pallet P while the carriage body 20 is adjacent a pallet first end P1, and the tow vehicle connecting means 100 can connect the tilt lever structure 60 to a tow vehicle TV such as a fork lift and the towing vehicle TV can advance away from the pallet P and thereby pull the tilt lever structure 60 away from the pallet P, tilting the carriage body 20 upward to ride on the carriage wheels 50 and thereby lifting the pallet first end P1 while the opposing pallet second end P2 rests on a support surface SS and is dragged over the support surface SS as the carriage 10 and pallet P are towed.

The carriage body 20 preferably takes the form of a channel member formed of steel. FIG. 4 is cross-sectional view of the preferred carriage body 20 and of a pallet lifting arm 30 fitted into an arm receiving tube 32 welded within the channel member forming the carriage body 20. A bracing plate 34 is welded across the open face of the channel member 20 with receiving tube passing port 32a for providing structural support to the arm receiving tube 32 and pallet lifting arm 30 fitted into the lifting arm receiving tube 32. A receiving tube pin 36 preferably fits through a receiving tube port 36a in each receiving tube 32 registering with corresponding ports in each lifting arm 30 to releasibly secure the lifting arm 30 in its receiving tube 32. Lifting arms 30 preferably are tubes of square cross-section. It is noted that one or more lifting arm spacers 30a having nesting protrusions 30b fitting into registering nesting ports 30c may be provided to permit proper engagement of pallets P which are taller than usual. It is also noted that the items I on pallets P preferably are secured against falling by straps S connected on one side of the bottom pallet P, wrapped over the stack of items I and pulled tight and secured to the opposing side of the bottom pallet P.

A typical pallet P includes two spaced apart pallet ribs PR and a pallet top panel TP and a pallet bottom panel BP and an open pallet interior PI. For purposes of this application, a pallet P to be lifted by the present tow carriage 10 be a single pallet P or a stack of pallets P each loaded with boxes or other items I for transport. The pallet engagement structure 80 preferably includes two pallet hook members 82 in the form of elongate rods each having a member hooking end 84 and a member locking end 86. Member hooking ends 84 preferably each include a spike 84a extending forwardly to releasibly penetrate a pallet rib PR to secure the pallet rib PR against lateral movement during pallet P towing. Each hook member 82 fits through the open pallet interior PI so the member hooking ends 84 hook opposing upright pallet ribs PR at the pallet second end P2 and the member locking ends 86 protrude out of the pallet first end P1. The carriage body 20 preferably has two longitudinally spaced apart series of hook member passing slots 22 at each carriage body 20 end. The hook member locking ends 86 are fitted forwardly through respective hook member passing slots 22 selected within the respective slot 22 sets for matching the spacing of the pallet ribs PR of the particular pallet P. A hook holding pin 28 is fitted through a port 86a in each hook member locking end 86 forward of the carriage body 20 to abut the carriage body 20 when the carriage 10 is towed.

Each wheel mounting structure 40 preferably includes a pair of wheel mounting brackets 42 protruding forwardly from the carriage body 20, having registering wheel bracket ports 42a through which a wheel axle 44 is fitted and on which a cylindrical carriage wheel 50 is mounted between the brackets 42 making up each pair, the wheel 50 protruding downwardly below the carriage body 20.

The tilt lever structure 60 preferably includes two laterally spaced apart upright tilt brackets 62 secured at tilt bracket 62 lower ends to the carriage body 20 and having tilt bracket connection ports 62a at tilt bracket 62 upper ends and including upper and lower linking struts 64 extending between and structurally interconnecting the tilt brackets 62. The tow vehicle connecting means 100 preferably include a linking chain 102 connected to the tilt bracket connection ports 62a and extending between the tilt brackets 62, and a pull chain 104 connected to the linking chain 102 and to the tow vehicle TV. The pull chain 104 is connected to the middle of the linking chain 102 to pull the pallet P directly forwardly, and is connected toward the right end of the linking chain 102 to pull the pallet P in a forward right turn, and is connected toward the left end of the linking chain 102 to pull the pallet P in a forward left turn.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A pallet tow carriage for engaging a pallet having a pallet first end and a pallet second end and a pallet top panel and a pallet bottom panel and a pallet interior for towing, comprising:
a carriage body for positioning at a first end of a pallet, first and second wheel mounting structures secured to said carriage body in spaced relation from each other, a tilt lever structure fastened to said carriage body and extending upwardly from said carriage body and a lifting arm structure extending rearwardly from the carriage body for fitting into a pallet interior;
a carriage wheel rotatably mounted to each said wheel mounting structure and extending below said carriage body;
a pallet engagement structure connected to said carriage body for connecting a pallet to said carriage body;
and tow vehicle connecting means for connecting said tilt lever structure to a tow vehicle;
such that said pallet engagement structure can engage a pallet while said carriage body is adjacent a pallet first end, and said tow vehicle connecting means can connect said tilt lever structure to a tow vehicle and said towing vehicle can advance away from the pallet and thereby pull said tilt lever structure away from the pallet, tilting said carriage body upward to ride on said carriage wheels and thereby lifting the pallet first end while the opposing pallet second end rests on a support surface and is dragged over the support surface as said carriage and the pallet are towed.

2. The pallet tow carriage of claim 1, wherein the pallet has two spaced apart pallet ribs, a top panel, an bottom panel and an open interior, wherein said pallet engagement structure comprises two pallet hook members in the form of elongate rods each having a member hooking end and a member locking end, such that each said hook member can be fitted through a pallet and said member hooking ends hook opposing upright pallet ribs at a pallet second end and said hook member locking ends protrude out of said pallet first end.

3. The pallet tow carriage of claim 1, wherein said carriage body comprises a channel member having two carriage body ends and two longitudinally spaced apart series of hook member passing slots at each carriage body end, such that said hook member locking ends can be fitted forwardly through respective said hook member passing slots selected within the respective said slot sets for matching the spacing of pallet ribs of a particular pallet to be engaged.

4. The pallet tow carriage of claim 1, wherein each said wheel mounting structure comprises a pair of wheel mounting brackets protruding forwardly from said carriage body, having registering wheel bracket ports through which a wheel axle is fitted and on which a cylindrical carriage wheel is mounted between said wheel mounting brackets forming each bracket pair, wherein each said wheel protrudes downwardly below said channel member.

5. The pallet tow carriage of claim 2, additionally comprising a hook holding pin fitted through a port in each said hook member locking end forward of said carriage body to abut said carriage body when said carriage body is towed.

6. The pallet tow carriage of claim 4, wherein each said hook member hooking end comprises a forward protruding spike for engaging a pallet rib.

7. The pallet tow carriage of claim 4, wherein said tilt lever structure comprises two laterally spaced apart upright tilt brackets secured at tilt bracket lower ends to said carriage body and having tilt bracket connection ports at tilt bracket upper ends and comprising a linking strut extending between and structurally interconnecting said tilt brackets.

8. The pallet tow carriage of claim 4, wherein said tow vehicle connecting means comprises:
a linking chain connected to said tilt bracket connection ports and extending between said tilt brackets;
and a pull chain connected to the linking chain and to the tow vehicle.

9. A pallet tow carriage for engaging a pallet having a pallet first end and a pallet second-end and a pallet top panel and a pallet bottom panel and a pallet interior for towing, comprising:
a carriage body for positioning at a first end of a pallet, a wheel mounting structure secured to said carriage body and a tilt lever structure fastened to said carriage body and extending upwardly from said carriage body and a lifting arm structure extending rearwardly from the carriage body for fitting into a pallet interior;
a carriage wheel rotatably mounted to said wheel mounting structure and extending below said carriage body;
a pallet engagement structure connected to said carriage body for connecting a pallet to said carriage body;
and tow vehicle connecting means for connecting said tilt lever structure to a tow vehicle;
such that said pallet engagement structure can engage a pallet while said carriage body is adjacent a pallet first end, and said tow vehicle connecting means can connect said tilt lever structure to a tow vehicle and said towing vehicle can advance away from the pallet and thereby pull said tilt lever structure away from the pallet, tilting said carriage body upward to ride on said carriage wheel and thereby lifting the pallet first end while the opposing pallet second end rests on a support surface and is dragged over the support surface as said carriage and the pallet are towed.

10. The pallet tow carriage of claim 9, wherein the pallet has two spaced apart pallet ribs, a top panel, an bottom panel and an open interior, wherein said pallet engagement structure comprises two pallet hook members in the form of elongate rods each having a member hooking end and a member locking end, such that each said hook member can be fitted through a pallet and said member hooking ends hook opposing upright pallet ribs at a pallet second end and said hook member locking ends protrude out of said pallet first end; and comprising a hook holding pin fitted through a port in each said hook member locking end forward of said carriage body to abut said carriage body when said carriage body is towed.
